(19) United States
(12) Patent Application Publication
(10) Pub. No.: US 2011/0099057 A1
(43) Pub. Date: Apr. 28, 2011

(54) SYSTEM AND METHOD FOR USING A CARD HAVING A 2D BARCODE TO DIRECT A CONSUMER TO CONTENT ON A GLOBAL COMMUNICATIONS NETWORK

(75) Inventor: Joseph Tenyer, Barrington, IL (US)

(73) Assignee: JET LITHOCOLOR, INC., Downers Grove, IL (US)

(21) Appl. No.: 12/604,029

(22) Filed: Oct. 22, 2009

(51) Int. Cl. G06Q 30/00; G06F 17/00

(52) U.S. Cl. 705/14.39; 235/380

(57) ABSTRACT

A system and method whereby a card is usable to direct a consumer to content on a global communications network, such as an Internet web page. The card is provided with a 2D barcode having encoded data that is representative of a location on the global communications network, the location having the content. When a device is used to read the 2D barcode from the card, the device is caused to access the content at the location on the global communications network that is associated with the data encoded in the 2D barcode.

### BACKGROUND

The use of two-dimensional (“2D”) barcodes to store information is generally known in the art. For example, U.S. Pat. No. 6,568,599, entitled “Disposable Coupon Card Providing A Plurality Of Coupon Discount Offers,” describes a method for providing a consumer with a plurality of coupon discount offers from one or more manufacturers by providing the consumer with a disposable coupon card having a 2D barcode printed thereon. The 2D barcode functions to encode reference numbers for each of the coupon discount offers while information that describes each of the discount coupon offers is also printed on the card. Cards carrying the coupon discount offers may be delivered to consumers by being included in distributed newspapers, circulars, mailers, and the like.

It is also known in the art to use a product barcode to generally direct a consumer to a location on a global communications network, such as the Internet. For example, U.S. Pat. No. 7,596,786, entitled “Method And Apparatus For Utilizing An Existing Product Code To Issue A Match To A Predetermined Location On A Global communications network,” describes a system and method for providing an interconnection relationship between a product and a desired location on a global communications network. To this end, when a product barcode is read by a device, the read product barcode is decoded to obtain routing information. The routing information is then used to define the manner by which the desired location is accessed via the global communications network.

Each of these publications is incorporated herein by reference in its entirety.

### SUMMARY

The following generally describes a system and method whereby a card is usable to direct a consumer to content on a global communications network, such as an Internet web page. The card is provided with a 2D barcode having encoded data that is representative of a location on the global communications network, the location having the content. When a device is used to read the 2D barcode from the card, the device is caused to access the content at the location on the global communications network that is associated with the data encoded in the 2D barcode.

A better understanding of the objects, advantages, features, properties and relationships of the novel card will be obtained from the following detailed description and accompanying drawing which sets forth an illustrative, preferred embodiment that is indicative of the various ways in which the principles of the invention may be employed.

### BRIEF DESCRIPTION OF THE DRAWINGS

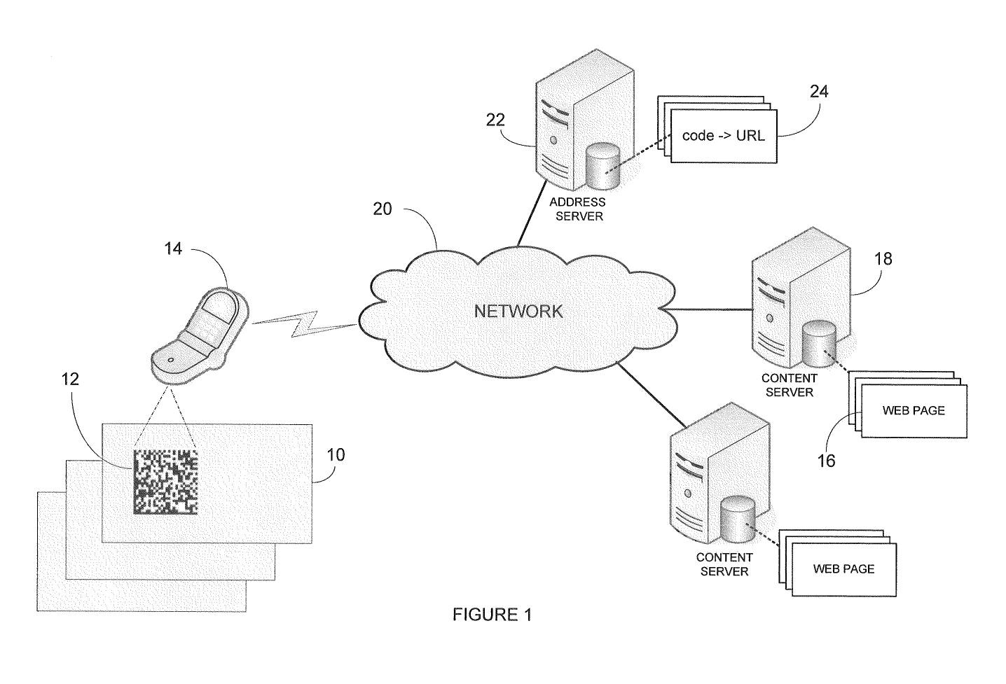

For a better understanding of the invention reference may be made to FIG. 1 which illustrates an exemplary system and method for using a card having a 2D barcode to direct a consumer to content on a global communications network.

### DETAILED DESCRIPTION

Referring now to the FIG. 1, a card 10, such as a gift card, loyalty card, membership card, coupon card, and the like, is provided with a 2D barcode 12. The 2D barcode 12 is preferably printed on the card 10 using any of a thermal, DoD, inkjet, laser, or offset printing method. While the card 10 may be manufactured to have any desired size and shape and may be constructed using any desired material, such as paper, plastic, etc., in a preferred embodiment the card 10 is a laminated plastic card having the approximate size of a credit card. When applicable, data indicative of a discount offer, incentive offer, dollar amount, or the like that is associated with the card can be encoded within the 2D barcode, be provided on a magnetic strip associated with the card, be printed on the card, be stored in a memory of the card, etc.

The 2D barcode 12 provided to the card 10 functions to link the card 10 with content 16 that is made available by a content server 18 residing on a global communications network 20, such as the Internet. To this end, the card 10 is linked with the content via use of a card reading device 14. While the card reading device 14 is illustrated in the exemplary form of a cell phone having, for example, a bar code reader, e.g., a camera and associated software, a display, input elements (such as a keypad), Internet connectivity, and an Internet browser application, it is to be appreciated that the card reading device 14 can be any type of computing device, point of sale device, kiosk device, etc., having such elements as needed for a particular application. While not illustrated, the card reading device 14 may have an associated printer for printing content, e.g., a coupon, that is obtained from the content server 18.

The 2D barcode 12 contains encoded data which is mapped to a specific location on the network 20. In this manner, when the 2D barcode 12 is read by card reading device 14, software resident on the card reading device 14 functions to provide the read 2D barcode data to address server 22. The address server 22 then uses a barcode to URL mapping table 24 to identify a URL for the barcode. The address server 22 then passes the identified URL back to the card reading device 14 and the software resident on the card reading device 14 uses the URL to access an appropriate content server 18 and corresponding content, such as a web page 16. While this described example includes the use of an intermediate address server 22, it is to be appreciated that the software resident on the card reading device 14 may itself function to determine a URL corresponding to a read 2D barcode and, as such, the card reading device 14 may directly access an appropriate content server 18 in response to reading a 2D barcode 12. As will also be appreciated, the content that is made available to the consumer in this manner may include, without limitation, information, a reward, a coupon, etc. concerning an item, service, organization, or the like that is associated with the card 10, e.g., associated with a provider of the card 10.

While the foregoing example provides multiple cards 10 with a common 2D barcode 12 such that multiple consumers can use a card 10 to access the same content, it is to be appreciated that the 2D barcode 12 may alternatively or additionally include data which would function to provide each of multiple cards 10 with a unique identifier such that multiple consumers can use a card 10 to access unique content. In such an example, the 2D barcode 12 may include, without limitation, a unique identifying number which unique indentifying number may be further linked to a specific consumer, e.g., a frequent shopper number, frequent flier number, preferred customer membership number or the like. In this manner, when the unique identifying number in the 2D barcode is read by the card reading device 14, the consumer may be directed to an appropriate content server 18 and content 16 that has been specifically selected for that consumer, such as a consumer specific coupon or the like. The manner by which the appropriate content server 18 and content 16 is accessed would be performed as described above using, for example, a URL (directing a browser to content server 18/content 16) and barcode data mapping table.

From the foregoing it will be appreciated that the subject inventive cards have the advantage of providing a link between a card and the marketing power of the Internet. In particular, the subject inventive cards have the advantage of providing marketers with the ability to take consumers to either static or common content with information for a particular item, organization, or the like (a many to one application) or to take consumers to content for a particular item, organization, or the like that is customized to a particular consumer (a one to one application). Thus, while specific examples of systems and methods for using a card having a 2D barcode to direct a consumer to content on a global communications network have been described in detail, it will be appreciated by those skilled in the art that various modifications and alternatives to those details could be developed in light of the overall teachings of this disclosure to thereby obtain the advantages above noted. Accordingly, the particular arrangements disclosed are meant to be illustrative only and not limiting as to the scope of the invention which is to be given the full breadth of the appended claims and any equivalents thereof.

What is claimed is:

1. A method for using a card to direct a consumer to content, comprising:
providing to the card a 2D barcode, the 2D barcode having encoded data that is representative of a location on the global communications network, the location on the global communications network having the content; and
causing a device to access the content at the location on the global communications network that is associated with the data encoded in the 2D barcode in response to the device reading the 2D barcode provided to the card.

2. The method as recited in claim 1, wherein the card comprises a gift card.

3. The method as recited in claim 1, wherein the card comprises a loyalty card.

4. The method as recited in claim 1, wherein the card comprises a membership card.

5. The method as recited in claim 1, wherein the 2D barcode is printed on the card using a thermal printing technique.

6. The method as recited in claim 1, wherein the 2D barcode is printed on the card using an inkjet printing technique.

7. The method as recited in claim 1, wherein the 2D barcode is printed on the card using a laser printing technique.

8. The method as recited in claim 1, wherein the 2D barcode is printed on the card using an offset printing technique.

9. The method as recited in claim 1, wherein the 2D barcode is encoded with data that is unique to the card such that the accessed content is also unique to the card.

10. The method as recited in claim 9, wherein the 2D barcode is encoded with data representative of a customer membership number.

11. The method as recited in claim 9, wherein the customer membership number comprises a frequent flier number.

12. The method as recited in claim 9, wherein the customer membership number comprises a customer loyalty number.

13. The method as recited in claim 1, comprising causing the device to provide the data read from the 2D barcode to an address server to obtain from the address server an address for the location on the global communications network that is associated with the data encoded in the 2D barcode.

14. The method as recited in claim 1, wherein the card comprises a coupon.

15. The method as recited in claim 1, wherein the card carries data indicative of a discount offer.

16. The method as recited in claim 1, wherein the card carries data indicative of an incentive offer.
